(19) United States
(12) Patent Application Publication
(10) Pub. No.: US 2012/0083289 A1
(43) Pub. Date: Apr. 5, 2012

(54) METHOD, DEVICE AND SYSTEM FOR DETERMINING POSITION INFORMATION

(75) Inventors: Ping Li, Shanghai (CN); Kui Tu, Shanghai (CN)

(73) Assignee: China Mobile Group Shanghai Corporation, Shanghai (CN)

(21) Appl. No.: 13/377,127

(22) PCT Filed: Jun. 8, 2010
(86) PCT No.: PCT/CN2010/000804

§ 371 Date: Dec. 8, 2011

(30) Foreign Application Priority Data
Jun. 8, 2009 (CN) 200910052927.9

(51) Int. Cl. H04W 24/00

(52) U.S. Cl. 455/456.1

(57) ABSTRACT

A method, device and system for determining position information are used to avoid the defects which result from the way of determining the position information of a wireless sensor node in the prior art. The method for determining the position information provided by the present invention is applied to a wireless sensor network, and includes the following steps: the current position information of a communication network node in the network is acquired; the acquired position information is determined to be the current position information of a wireless sensor node which provides service data to the communication network node.

### FIELD

The present invention relates to the field of sensors and communications and particularly to a method, device and system for determining location information.

### BACKGROUND

In recent years, it has become practicable to design and apply radio sensors with low power consumption, in which sensing and radio communication functions are integrated, along with rapid development of Micro-Electro-Mechanical Systems (MEMS) and radio communication technologies, and a radio sensor network emerging therewith will find its tremendous prospect of applications in the fields of medical treatment, public security, military, environmental surveillance, etc.

A radio sensor network typically includes two types of nodes, one of which relates to radio sensor nodes on which various types of sensors are equipped. An ambient condition is detected and sensed through the sensors. The radio sensor nodes are used to collect service data acquired by the sensors and to provide the network side with the service data, where the service data provided from the radio sensor nodes to the network side includes location information of the sensors and/or the radio sensor nodes corresponding to the service data. The current location information of the sensors and/or the radio sensor nodes is crucial information, and the service data provided from the radio sensor nodes to the network side would be almost useless in any application without the location information. In a radio sensor network applied to environmental and weather surveillance, for example, if current service data of an airport or a railway station, e.g., an air pollution index, air temperature, humidity, etc., is currently required at the network side, then radio sensor nodes located at the air port or the railway station provide the network side the service data acquired by sensors distributed throughout the air port or the railway station along with location information of the sensors and/or the radio sensor nodes per se distributed throughout the air port or the railway station so that the network side can be aware of that the service data provided from the radio sensor nodes originates from the air port or the railway station and thereby take a corresponding measure or publish corresponding information, e.g., clean the environment of the airport with an excessive air pollution index etc. It shall be noted that since the respective radio sensor nodes are at a typically short distance to their corresponding sensors, the location information of the radio sensor nodes will not be distinguished hereinafter from the location information of the sensors but location information of a radio sensor node and location information of a sensor will be directly referred to collectively as location information of a radio sensor node. Furthermore the sensors will be regarded hereinafter as a part of the radio sensor nodes, and the concept of a radio sensor node will not be distinguished from the concept of a sensor, and a radio sensor node and a sensor corresponding to the radio sensor node will be referred to collectively as a radio sensor node.

In the radio sensor network, there are another type of nodes, sink nodes, in addition to the foregoing radio sensor nodes, and the sink nodes function to establish a communication relationship with sensors and/or sensor nodes within a specific preset range of proximity and to collect service data provided from the sensors and/or the sensor nodes with a communication relationship established with the sink nodes. Particularly the distance between a mobile terminal and a radio sensor node is not above a preset communication distance threshold below which a communication relationship can be established between the mobile terminal and the radio sensor node. In the radio sensor network, a sink node is typically equipped with more than two network interfaces, where one of the interfaces is a radio sensor network interface via which the sink node communicates with a radio sensor node, and another interface is a radio communication network interface via which the sink node accesses a radio communication network. Generally the sink node may be a mobile terminal capable of accessing both the radio sensor network and the radio communication network concurrently.

In the prior art, when location information of radio sensor nodes is provided from the radio sensor nodes, the location information is determined from the location information of the respective radio sensor nodes preset in the radio sensor nodes, and since there is a large amount of data of the radio sensor nodes extensively distributed throughout a radio sensor network, a lot of manpower and material resources have to be consumed to preset the location information into the radio sensor nodes. Furthermore presetting of the location information into the radio sensor nodes may discourage the radio sensor nodes from being reused. For example, if it is required to deploy radio sensor nodes in a specific area, then corresponding location information of the radio sensor nodes has to be set for the radio sensor nodes deployed in the area, and if it is required to redeploy the radio sensor nodes in the area into another area, then corresponding location information of the radio sensor nodes has to be set for the redeployed radio sensor nodes.

### SUMMARY

Embodiments of the invention provide a method, device and system for determining location information to obviate the drawback of having a lot of manpower and material resources consumed to determine location information of radio sensor nodes in the prior art.

In view of this, embodiments of the invention provide the following technical solutions.

A method for determining location information is applied in a radio sensor network and includes: acquiring current location information of a communication network node in the network; and determining the acquired location information as current location information of a radio sensor node providing service data to the communication network node.

Preferably in an embodiment of the invention, acquiring the current location information of the communication network node includes:

acquiring the current location information of the communication network node using a global positioning system receiver of the communication network node; or acquiring the current location information of the communication network node through positioning a cell; or transmitting a Location Based Service, LBS, service request to a LBS platform and receiving the current location information of the communication network node fed back from the LBS platform in response to the LBS service request.

Preferably in an embodiment of the invention, the method further includes: determining whether the communication network node receives an indicator indicating a necessity to provide the current location information of the radio sensor node providing the service data to the communication network node, before acquiring the location information of the communication network node in the network.

Preferably in an embodiment of the invention, the method further includes: writing the determined current location information of the radio sensor node into data bits reserved for writing the location information in a service data packet constituted of the service data; and providing a corresponding demander with the service data packet into which the current location information of the radio sensor node is written, after determining the acquired location information as the current location information of the radio sensor node providing the service data to the communication network node.

Preferably in an embodiment of the invention, the method further includes: providing a corresponding demander with a correspondence relationship between the determined current location information of the radio sensor node and a service data packet constituted of the service data, after determining the acquired location information as the current location information of the radio sensor node providing the service data to the communication network node.

Preferably in an embodiment of the invention, the method further includes: determining whether the distance between the communication network node and the radio sensor node is not above a preset distance threshold, before acquiring the current location information of the communication network node in the network.

Preferably in an embodiment of the invention, the communication network node is a sink node in the network or a base station to which the sink node is subordinated.

A device for determining location information is applied in a radio sensor network and includes: an acquisition unit configured to acquire current location information of a communication network node in the network; and a determination unit configured to determine the location information acquired by the acquisition unit as current location information of a radio sensor node providing service data to the communication network node.

A system for determining location information is applied in a radio sensor network and includes: a communication network node; a radio sensor node configured to provide the communication network node with serviced data; and a location information determination device configured to acquire current location information of the communication network node in the network and to determine the acquired location information as current location information of the radio sensor node.

In the embodiments of the invention, current location information of a communication network node located in a radio sensor network is acquired, and the acquired location information is taken as current location information of a radio sensor node providing service data to the communication network node, and since the radio sensor node capable of providing service data to the communication network node is at a typically short distance to the communication network node (the distance therebetween is not above a preset communication distance threshold below which a communication relationship can be established between the communication network node and the radio sensor node), it is practical to take the current location information of the communication network node as the current location information of the radio sensor nodes providing the service data to the communication network node under the precondition of satisfying a requirement on the precision at which the location information of the radio sensor nodes is positioned. The solution according to the embodiment of the invention can determine the location information of the sensors without presetting the location information of the respective radio sensor nodes, thereby conserving manpower and material resources required to preset the location information, and furthermore the solution according to the embodiment of the invention will not discourage the radio sensor nodes from being reused.

### BRIEF DESCRIPTION OF THE DRAWINGS

FIG. 1 is a schematic diagram of a specific flow of a method for determining location information according to an embodiment of the invention;

FIG. 2a is a schematic diagram of a scenario in which a first embodiment of the invention is applied;

FIG. 2b is a schematic diagram of a specific implementation of the first embodiment of the invention;

FIG. 3a is a schematic diagram of a scenario in which a second embodiment of the invention is applied;

FIG. 3b is a schematic diagram of a specific implementation of the second embodiment of the invention;

FIG. 4a is a schematic diagram of a scenario in which a third embodiment of the invention is applied;

FIG. 4b is a schematic diagram of a specific implementation of the third embodiment of the invention;

FIG. 5 is a schematic diagram of a specific structure of a device for determining location information according to an embodiment of the invention; and

FIG. 6 is a schematic diagram of a specific structure of a system for determining location information according to an embodiment of the invention.

### DETAILED DESCRIPTION

An embodiment of the invention firstly provides a method for determining location information applied in a radio sensor network, where current location information of a communication network node is acquired, and the acquired location information is taken as current location information of a radio sensor node providing service data received by the communication network node at its own current location. In the embodiment of the invention, the communication network node may be a sink node in a radio sensor network or a base station to which the sink node is subordinated, so that since the communication network node is at a typically short distance to the radio sensor node with which the communication network node can establish a communication relationship, it is practical to take the current location information of the communication network node as the current location information of the radio sensor node transmitting the service data to the communication network node under the precondition of satisfying a requirement on the precision at which the location information of the radio sensor node is positioned.

A general implementation principle, specific implementations and their corresponding attainable advantageous effects of technical solutions according to the embodiments of the invention will be set forth in details below with reference to the drawings.

Reference is made to FIG. 1 illustrating a schematic diagram of a specific flow of a method for determining location information according to an embodiment of the invention, which includes the following operations 11 and 12.

The operation 11 is to acquire current location information of a communication network node in a radio sensor network; and

The operation 12 is to determine the acquired current location information of the communication network node as current location information of a radio sensor node providing service data received by the communication network node at its own current location.

In the method for determining location information according to the embodiment of the invention, location information of respective radio sensor nodes can be determined without presetting the location information of the radio sensor nodes, thereby obviating the drawbacks of having a lot of manpower and material resources consumed to determine location information of radio sensor nodes and of discoursing the radio sensor nodes from being reused in the prior art.

In an embodiment of the invention, firstly sensors acquiring service data provide the acquired service data to sensor nodes, which then transmit the service data to a communication network node capable of communication with the sensor nodes (here the communication network node is a sink node in the radio sensor network), and since in the embodiment of the invention the sensor nodes do not provide any current location information of the sensors while transmitting the service data, it is necessary for the communication network node receiving the service data to determine current location information of the radio sensor nodes corresponding to the service data. Since in the radio sensor network the communication network node is a sink node or a base station to which the sink node is subordinated, the communication network node is at a short distance to the radio sensor nodes providing the service data to the communication network node, so that an allowable required precision range of the current location information of the radio sensor nodes can generally be satisfied by taking location information of the communication network node as the current location information of the radio sensor nodes, and here it is practical to take the current location information of the communication network node receiving the service data as the current location information of the radio sensor nodes providing the service data. In some scenarios where a radio sensor network is applied, for example, where environmental surveillance is performed over a radio sensor network, one or more radio sensor nodes for environmental surveillance tend to be deployed in a specific local area, and it is not necessary to further subdivide the locations of the radio sensor nodes distributed in the local area while accommodating an allowable required precision range of the location information. If it is required to determine only a pollution condition throughout the south square of a railway station, for example, then the required precision will be so low that typically the precision up to 100 and even 500 meters will suffice but the precision up to 1 meter will be unnecessary.

Preferably in an embodiment of the invention, the following operation may further be included before acquiring the current location information of the communication network node in the radio sensor network in view of a high requirement on the precision at which the radio sensor node is positioned: it is determined whether the distance between the communication network node and the radio sensor node is not above preset distance threshold which can be adjusted according to the precision at which the radio sensor node is positioned so that the distance threshold can be set small if the positioning precision is high or large if the positioning precision is low to thereby satisfy the requirement on the precision at which the radio sensor nodes are positioned.

Furthermore since the sensor nodes will not provide any current location information of the radio sensor nodes while transmitting the service data, it is preferable to further include before the operation 11 in the embodiment of the invention determining whether the communication network node receives an indicator indicating a necessity to determine the current location information of the radio sensor node providing the service data received by the communication network node, and the operations 11 and 12 will be performed sequentially upon determining reception of the indicator by the sink node.

In an embodiment of the invention, an Location Based Service (LBS) platform in the prior art can function to locate the communication network node and therefore can be used to acquire the current location information of the communication network node in the embodiment of the invention, so that the current location information of the communication network node in the radio sensor network can preferably be acquired in any one or combination of the following ways:

the current location information of the communication network node is acquired with a global positioning system receiver of the communication network node per se; or the current location information of the communication network node is acquired through positioning a cell; or an LBS service request is transmitted to the Location Based Service (LBS) platform, and the current location information of the communication network node fed back from the LBS platform in response to the LBS service request is received.

An executor of the foregoing method for determining location information according to the embodiment of the invention can be either the communication network node per se or a device for determining location information, and the communication network node can be a sink node (e.g., a mobile terminal, etc.) or a base station to which the sink node is subordinated. Hereinafter, scenarios in which the executor is a mobile terminal and a base station respectively will be detailed in specific embodiments, and furthermore a device for determining location information according to an embodiment of the invention will also be detailed.

Practical application flows of the method for determining location information according to the embodiments of the invention will be detailed below in three specific embodiments. It shall firstly be noted that in the embodiments of the invention a mobile terminal can be any of various mobile terminals including a portable PDA, a mobile phone or any other mobile terminal capable of information interaction with a mobile communication network, and furthermore the mobile terminal is provided with a module for accessing a radio sensor network and complies with a communication protocol of the radio sensor network, so that the mobile terminal satisfying the foregoing requirements and acting as a sink node of the radio sensor network is capable of establishing communication with a sensor node in the radio sensor network and parsing and processing a service data packet transmitted from the radio sensor node with a communication relationship established therewith. Furthermore the mobile communication network in the embodiments of the invention can be but not limited to a 2G network of, e.g., GSM, IS-95, etc., or a 3G network of e.g., TD-SCDMA, WCDMA, CDMA2000, WiMAX, etc., or a 4G mobile communication network of e.g., WiFi, LTE, etc., capable of providing a radio communication service, and the mobile communication network can further include devices necessary for radio communication of the mobile terminal, including nodes of a base station, a service platform (including a server), etc.

### The First Embodiment

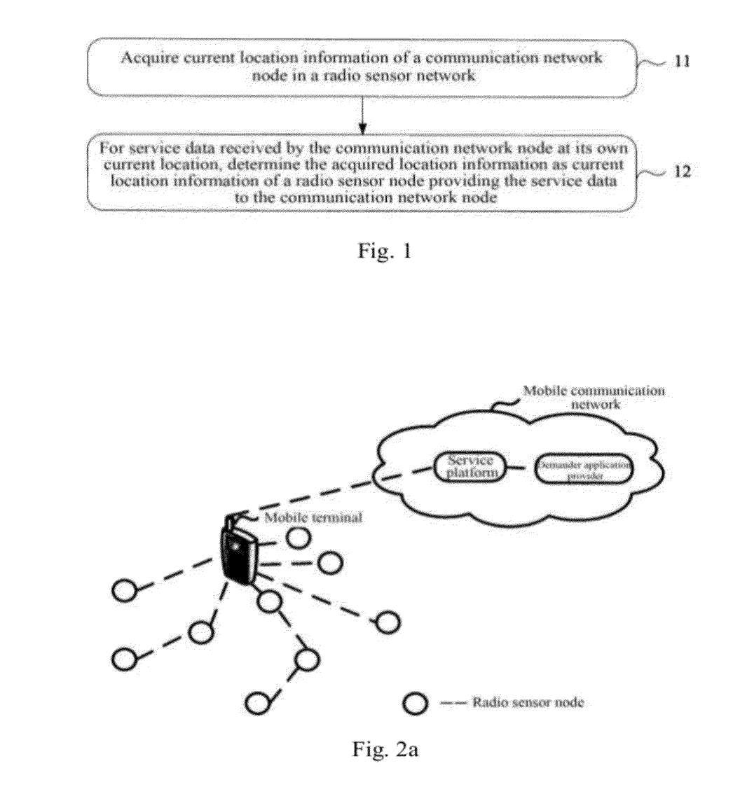

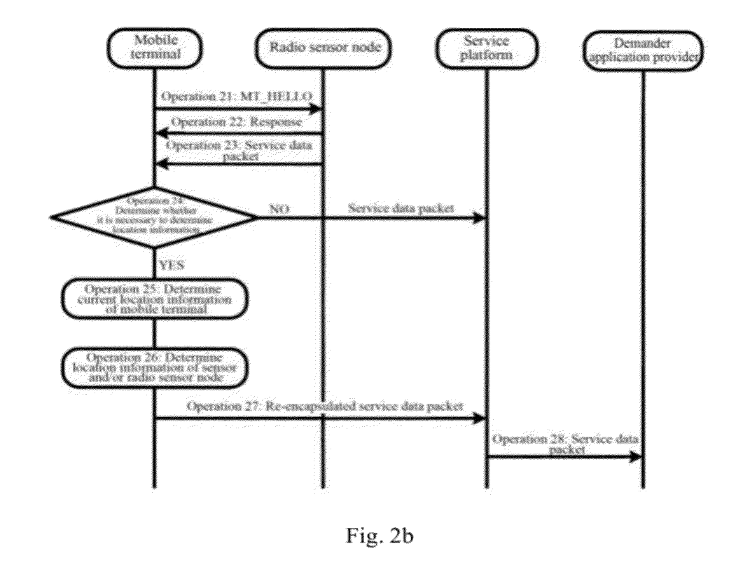

FIG. 2a illustrates a schematic diagram of a scenario in which the first embodiment of the invention is applied, where dotted lines in the figure represent communication relationships between a mobile terminal and radio sensor nodes, and FIG. 2b illustrates a specific implementation flow of the first embodiment of the invention, which includes the following operations 21 to 28.

In the operation 21, a mobile terminal broadcasts a HELLO message MT_HELLO to radio sensor nodes in an area where the mobile terminal is located;

In the operation 22, each of the radio sensor nodes feeds a response message back to the mobile terminal transmitting the MT_HELLO message upon reception of the MT_HELLO (the MT-HELLO can be transmitted to the radio sensor node from the mobile terminal communicating directly with the radio sensor node or after being hop-by-hop forwarded via other radio sensors under the condition of the distance between the radio sensor node and the mobile terminal transmitting the MT_HELLO being not above a preset distance threshold below which a communication relationship can be established, where the preset distance threshold can be, for example, a preset largest number of communication hops over the distance of the mobile terminal to the radio sensor node with a communication relationship which can be established therebetween) to establish radio communication with the mobile terminal and determines the mobile terminal as a sink node corresponding to service data transmitted from the radio sensor;

In the operation 23, each of the radio sensor nodes encapsulates its acquired service data into a service data packet transmitted to the mobile terminal, and in the method for determining location information according to the embodiment of the invention, the service data packet will not include any location information of the radio sensor node provided from the radio sensor node but can include an indicator indicating a necessity to determine location information of the radio sensor node providing the service data received by the mobile terminal. Furthermore each of the radio sensor nodes can alternatively carry the indicator in another indication message associated with the service data packet while transmitting the service data packet;

In the operation 24, correspondingly to the two alternatives described in the operation 23, if the mobile terminal receives only the service data packet, then it can parse the service data packet and determine from the indicator acquired by parsing the service data packet the necessity to determine the current location information of the radio sensor node corresponding to the service data packet received by the mobile terminal, and then the flow jumps to the operation 25; or if the mobile terminal receives the service data packet together with the indication message transmitted from the radio sensor node, then the mobile terminal determines from the indicator carried in the indication message the necessity to determine the current location information of the radio sensor node corresponding to the service data packet received by the mobile terminal, and then the flow also jumps to the operation 25. On the contrary, the mobile terminal transmits the received service data packet directly to a service platform in a mobile communication network if the mobile terminal does not receive the indicator (that is, if it determines no necessity to determine the current location information of the radio sensor node corresponding to the service data packet received by the mobile terminal) in the operation 24;

In the operation 25, the mobile terminal determines its own current location information, where the mobile terminal can determine the current location information of the mobile terminal per se, for example (but not limited to), with its own GPS receiver or through positioning a cell in a radio communication network as in the prior art or through positioning otherwise the mobile terminal in the mobile communication network as in the prior art. It shall be noted that the mobile terminal can select a method for determining a location where the mobile terminal is current located as appropriate to a requirement of different services on the precision of the location information.

In the operation 26, the mobile terminal determines its own current location information as the location information of the radio sensor node corresponding to the received service data packet, opens the service data packet, writes its own current location information into data bits reserved for writing the location information in the service data packet and then re-encapsulates the service data packet including the location information, where each of the sensor nodes can transmit the service data packet in which the data bits are reserved to the mobile terminal in the following communication format as depicted in Table 1 below:

TABLE 1

| | | | | |
|---|---|---|---|---|
| Header | . . . | . . . | Location information | . . . |
| | | | (reserved data bits) | |

In the operation 27, the mobile terminal uploads the service data packet re-encapsulated in the operation 26 to the service platform of the mobile communication network over the mobile communication network; and

In the operation 28, the service platform of the mobile communication network transmits the service data packet to a corresponding demander application provider, and the flow ends.

In the operation 26, a correspondence relationship between the location information of the mobile terminal (which may be specific coordinate information, etc.) and the service data packets acquired by and transmitted from the radio sensor nodes to the mobile terminal is as depicted in Table 2 below:

TABLE 2

| Current location | |
|---|---|
| information of | Radio sensor nodes corresponding |
| mobile terminal | to service data packets |
| Coordinates (X₁, Y₁) | Service data packets I, II and III |
| of location 1 of | originate respectively from radio |
| mobile terminal | sensor nodes a, b and c |
| Coordinates (X₂, Y₂) | Service data packets III, IV and V |
| of location 2 of | originate respectively from |
| mobile terminal | radio sensor nodes c, d and e |
| Coordinates (X₃, Y₃) | Service data packets VI and VII |
| of location 3 of | originate respectively from radio |
| mobile terminal | sensor nodes f and g |
| . . . | . . . |

As can be apparent from Table 2 above, when the mobile terminal moves to the location 1 and receives the service data packets I, II and III provided from the radio sensor nodes a, b and c, the mobile terminal determines the coordinates (X₁, Y₁) of its own location 1 as location information of the radio sensor nodes a, b and c providing the service data packets I, II and III, and so on. Furthermore if the right column of Table 2 above represents sensors corresponding to service data packets, then the mobile terminal can determine the coordinates of its own current location as location information of the sensors providing the service data packets

In an embodiment of the invention, a map list as depicted in Table 3 below can be adopted instead of the map list depicted in Table 2 above:

TABLE 3

| Location information of | |
|---|---|
| area into which current | |
| location of mobile | Radio sensor nodes corresponding |
| terminal falls | to service data packets |
| Mobile terminal is located | Service data packets I, II and III |
| in area 1 with location | originate respectively from |
| information of | radio sensor nodes a, b and c |
| “Railway station” | |
| Mobile terminal is located | Service data packets III, IV and V |
| in area 2 with location | originate respectively from |
| information of | radio sensor nodes c, d and e |
| “Air port” | |
| Mobile terminal is located | Service data packets VI and VII |
| in area 3 with location | originate respectively from radio |
| information of | sensor nodes f and g |
| “Amusement park” | |
| . . . | . . . |

As can be apparent from Table 3 above, when the mobile terminal moves to the area 2 and receives the service data packets III, IV and V provided from the radio sensor nodes c, d and e, the mobile terminal determines the location information (“Airport”) of the area in which it is currently located as location information of the radio sensor nodes c, d and e providing the service data packets III, IV and V, and so on

Furthermore in the operations 26 and 27, the mobile terminal may not open the service data packets but can instead establish directly the correspondence relationship between its own current location information and the service data packets and then provide the service platform of the mobile communication network with the correspondence relationship while transmitting the service data packets and the current location information of the mobile terminal corresponding to the service data packets respectively to the service platform.

As can be apparent from the foregoing first embodiment, since only a radio sensor node at a short distance to the mobile terminal (for example, a radio sensor located in the same communication cell as the mobile terminal in the cell is at a short distance thereto) can receive the MT_HELLO transmitted from the mobile terminal, it is practicable in the case of a relatively low precision requirement to determine the current location information of the mobile terminal as the location information of the radio sensor node at a short distance to the mobile terminal, which is corresponding to the service data reported from the radio sensor node in the method according to the embodiment of the invention. Since the location information of some or all of the sensors/radio sensor nodes corresponding to the service data can be determined simply with a smaller number of sink nodes instead of presetting the location information of the sensors in the respective radio sensor nodes in the embodiment of the invention, the implementation process thereof will be simple; and furthermore the location information of the sensors corresponding to the service data will not be uploaded while the radio sensor nodes upload the service data packets in the method according to the embodiment of the invention, therefore a processing resource of the radio sensors consumed when the radio sensors report the location information can be conserved on one hand and a transmission resource of the radio network can be conserved on the other hand in the method according to the embodiment of the invention.

Secondly it has been proposed in the prior art to install a Global Positioning System (GPS) receiver in a radio sensor node so that location information of the radio sensor node can be determined with the GPS receiver. In view of this, firstly it might be too costly to equip respective radio sensor nodes in a radio sensor network with a GPS receiver due to the large number of radio sensor nodes; and secondly it might be not easy to replace a power source of a radio sensor node due to the deployment characteristic of a radio sensor network, thus it might not be appropriate to install a power demanding GPS transducer on the radio sensor node if a long service lifetime of the radio sensor network is required. Furthermore the volume of a radio sensor node might be increased due to installation of a GPS transducer thereon, therefore it might not be appropriate to install a GPS transducer on radio sensor nodes of a radio sensor network. As can be apparent from comparison of this approach in the prior art with the method according to the embodiment of the invention, a positioning function of the mobile terminal acting as a sink node will suffice in the solution according to the embodiment of the invention as opposed to the solution proposed in the art to determining location information of respective radio sensor nodes by configuring the sensor nodes with a GPS receiver, therefore the solution according to the embodiment of the invention is characterized by being implemented at a low cost, with less power consumption of the radio sensor nodes and without increasing the volume of the radio sensor nodes.

### The Second Embodiment

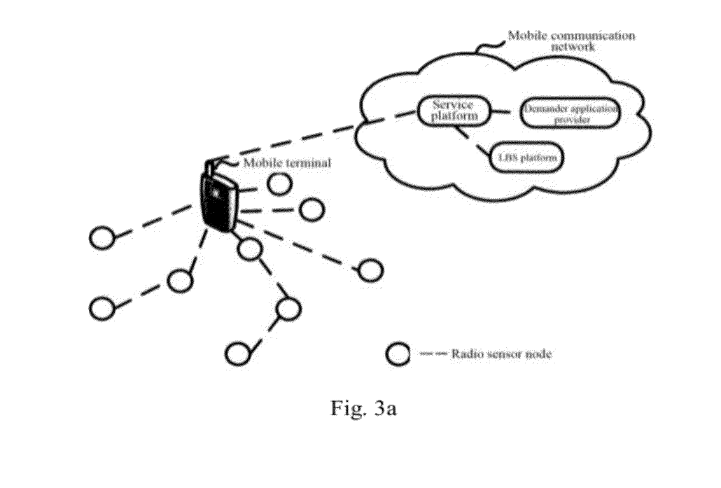

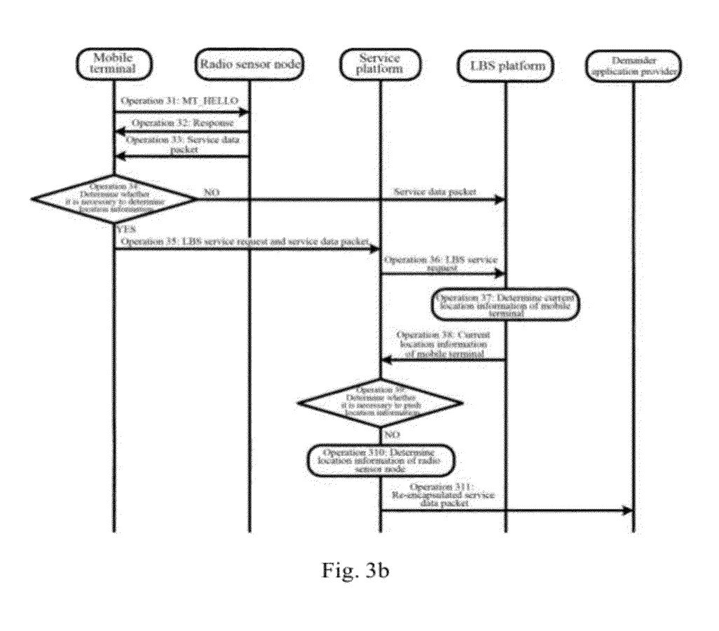

In the second embodiment of the invention, location information of a sensor is determined with a Location Based Service (LBS) platform in the prior art capable of functioning to position a mobile terminal. FIG. 3a illustrates a schematic diagram of a scenario in which the second embodiment of the invention is applied, and FIG. 3b illustrates a schematic diagram of a specific flow thereof, which includes the following operations 31 to 311.

In the operation 31, a mobile terminal broadcasts a HELLO message MT_HELLO to radio sensor nodes in an area where the mobile terminal is located;

In the operation 32, each of the radio sensor nodes feeds a response message back to the mobile terminal transmitting the MT_HELLO message upon reception of the MT_HELLO to establish radio communication with the mobile terminal and determines the mobile terminal as a sink node corresponding to service data transmitted from the radio sensor;

In the operation 33, each of the radio sensor nodes encapsulates its acquired service data into a service data packet transmitted to the mobile terminal, where the service data packet includes both the service data and an indicator indicating a necessity to determine location information of the radio sensor node providing the service data received by the mobile terminal. Furthermore each of the radio sensor nodes can alternatively carry the indicator in another indication message while transmitting the service data packet;

In the operation 34, correspondingly to the two alternatives described in the operation 33, if the mobile terminal receives only the service data packet, then it can parse the service data packet and determine from the indicator acquired by parsing the service data packet the necessity to determine the current location information of the radio sensor node providing the service data packet received by the mobile terminal, and then the flow jumps to the operation 35; or if the mobile terminal receives the service data packet together with the indication message transmitted from the radio sensor node, then the mobile terminal can determine from the indicator carried in the indication message the necessity to determine the current location information of the radio sensor node providing the service data packet received by the mobile terminal, and then the flow also jumps to the operation 35. On the contrary, the mobile terminal transmits the received service data packet directly to a service platform in a mobile communication network if the mobile terminal does not receive the indicator (that is, if it determines no necessity to determine the current location information of the radio sensor node providing the service data packet received by the mobile terminal) in the operation 34;

In the operation 35, the mobile terminal initiates an LBS service request to the service platform of the mobile communication network and transmits the service data packet transmitted from each of the radio sensor nodes to the service platform of the mobile communication network, and if the service data packet does not include the indicator indicating the necessity, then the mobile terminal can alternatively carry the indicator in an indication message and transmit the indication message together with the service data packet to the service platform of the radio sensors in the operation 35;

In the operation 36, the service platform of the mobile communication network forwards the LBS service request to an LBS platform as in an existing technical specification flow upon reception of the LBS service request transmitted from the mobile terminal;

In the operation 37, the LBS platform acquires location information of the mobile terminal from a mobile operator upon reception of the LBS service request, where the mobile operator can acquire the current location information of the mobile terminal by positioning the mobile terminal as in the prior art and provide the LBS platform with the acquired location information;

In the operation 38, the LBS platform transmits the acquired current location information of the mobile terminal to the service platform of the mobile communication network;

In the operation 39, in the prior art, the service platform of the mobile communication network transmits the LBS service request to the LBS platform and acquires current location information of the mobile terminal fed back from the LBS platform and then pushes a request result corresponding to the LBS service request (i.e., the current location information of the mobile terminal) to the mobile terminal transmitting the LBS service request, but in the embodiment of the invention, the service platform of the mobile communication network can determine from the indicator that the mobile terminal transmits the LBS service request not for the purpose of acquiring the current location information of the mobile terminal and therefore will not push the location to the mobile terminal;

In the operation 310, the service platform of the mobile communication network determines the acquired current location information of the mobile terminal as the location information of the radio sensor node providing the service data packet, opens the service data packet, writes the current location information of the mobile terminal into data bits reserved for writing the location information in the service data packet and then re-encapsulates the service data packet including the location information; and

In the operation 311, the service platform of the mobile communication network transmits the service data packet re-encapsulated in the operation 310 to a corresponding demander application provider, and the flow ends.

Like the first embodiment of the invention, in the operations 310 and 311, the service platform of the mobile communication network may not open the service data packet but can instead establish directly a correspondence relationship between the current location information of the mobile terminal and the service data packet and then provide the corresponding demander application provider with the correspondence relationship while transmitting the service data packet and the current location information of the mobile terminal corresponding to the service data packet respectively to the corresponding demander application provider.

### The Third Embodiment

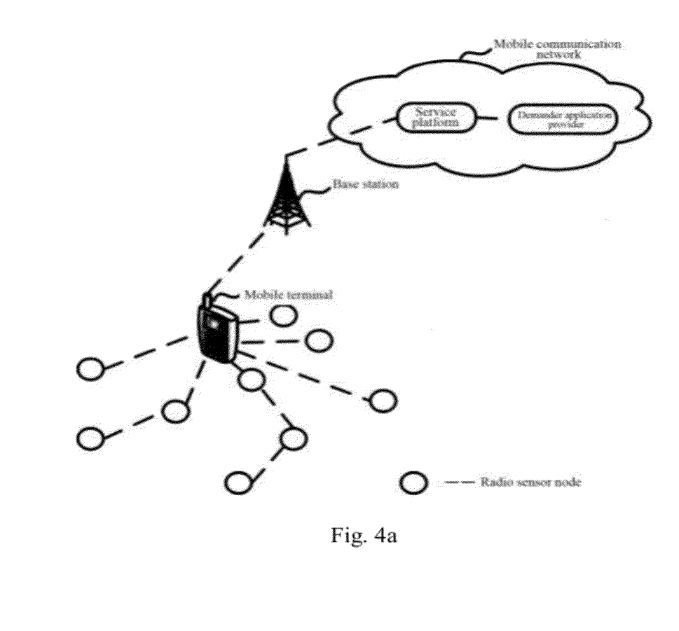

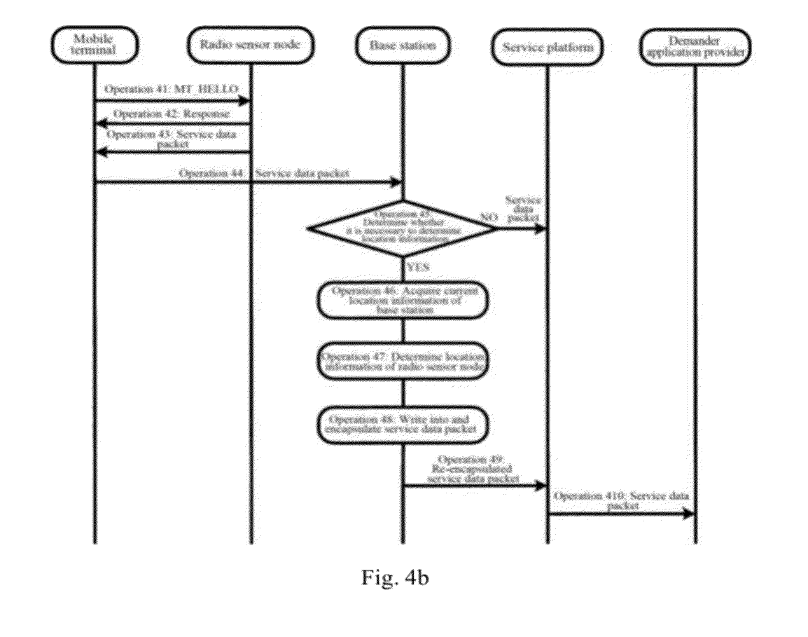

Instead of determining the current location information of the mobile terminal as the location information of the radio sensor nodes in the first and second embodiments of the invention, location information of a base station in a mobile communication network is determined as location information of radio sensor nodes in the third embodiment of the invention, where it is also practicable in the case of a relatively low precision requirement to determine location information of a base station as location information of a radio sensor node at a short distance to the base station in view of highly dense base stations (possibly a distance of only 100 to 200 meters between the base stations) in the prior art. Specifically, FIG. 4a illustrates a schematic diagram of a scenario in which the third embodiment of the invention is applied, and FIG. 4b illustrates a schematic diagram of a specific flow thereof, which includes the following operations 41 to 410.

n the operation 41, a mobile terminal broadcasts a HELLO message MT_HELLO to radio sensor nodes in an area where the mobile terminal is located;

In the operation 42, each of the radio sensor nodes feeds a response message back to the mobile terminal transmitting the MT_HELLO message upon reception of the MT_HELLO to establish radio communication with the mobile terminal and determines the mobile terminal as a sink node corresponding to service data transmitted from the radio sensor;

In the operation 43, each of the radio sensor nodes encapsulates its acquired service data into a service data packet transmitted to the mobile terminal, where the service data packet includes both the service data and an indicator indicating a necessity to determine location information of the radio sensor node providing the service data received by the mobile terminal. Furthermore each of the radio sensor nodes can alternatively carry the indicator in another indication message transmitted together with the service data packet to the mobile terminal;

In the operation 44, the mobile terminal transmits the service data packet to a base station controlling the area where the mobile terminal is currently located upon reception of the service data packet transmitted from each of the radio sensor nodes, and in this operation, the mobile terminal transmits the indication message including the indicator together with the service data packet to the base station if the mobile terminal receives the indication message from the radio sensor node together with the service data packet;

In the operation 45, the base station determines whether the indicator is received upon reception of the service data packet, and if it is determined that the indicator is received, then the flow jumps to the operation 46; otherwise, the base station transmits the received service data packet directly to a service platform in a mobile communication network;

In the operation 46, the base station acquires its own location information, and in an embodiment of the invention, the base station can acquire its own location information, for example (but not limited to), with its own GPS receiver (it is required or recommended that the base station be provided with a GPS positioning function for a CDMA system, a 3G system, particularly a TD-SCDMA system, and a future next-generation network system) or over an LBS platform as in the prior art or through a satellite positioning system.

In the operation 47, the base station determines its own location information as the location information of the radio sensor nodes providing the service data, and in this operation, the base station located at different locations can determine its own location information as the location information of the radio sensor nodes providing the service data in a mapping relationship as depicted in Table 4 below:

TABLE 4

| Location information | Radio sensor nodes corresponding |
|---|---|
| of base station | to service data packets |
| Coordinates (M₁,N₁) | Service data packets I, II and III |
| of location 1 of | originate respectively from radio |
| base station | sensor nodes a, b and c |
| Coordinates (M₂, N₂) | Service data packets III, IV and V |
| of location 2 of | originate respectively from |
| base station | radio sensor nodes c, d and e |
| Coordinates (M₃, N₃) | Service data packets VI and VII |
| of location 3 of | originate respectively from radio |
| base station | sensor nodes f and g |
| . . . | . . . |

As can be apparent from Table 4 above, when the mobile terminal moves into a control domain of the base station at the location 1 and receives the service data packets I, II and III provided from the radio sensor nodes a, b and c, the base station at the location 1 determines the coordinates (M₁, N₁) of its own location 1 as location information of the radio sensor nodes a, b and c (and/or the radio sensor nodes) providing the service data packets I, II and III, and so on.

In the operation 48, the base station opens the service data packet, writes its own current location information into data bits reserved for writing the location information in the service data packet and then re-encapsulates the service data packet including the location information;

In the operation 49, the base station uploads the service data packet re-encapsulated in the operation 48 to a service platform of a mobile communication network over the mobile communication network; and

In the operation 410, the service platform of the mobile communication network transmits the service data packet to a corresponding demander application provider, and the flow ends.

In the third embodiment of the invention, the method for determining location information according to the embodiment of the invention has been described by way of an example in which the base station receives the service data packet transmitted from the mobile terminal acting as a sink node, but in a practical application, the service data packet received by the base station can alternatively be a service data packet which is uploaded from a mobile terminal acting as a normal node in the radio sensor network (the normal node as mentioned here refers to a node other than a sink node) and to which location information of a sensor will be added (the data packet here can alternatively be any other data packet to which location information of a data acquisition point will be added) or a service data packet which is uploaded otherwise to the base station and to which location information of a sensor will be added (the data packet here can alternatively be any other data packet to which location information of a data acquisition point will be added).

Furthermore a service platform of a radio communication network can alternatively acquire the location information of the base station as the location information of each of the radio sensor nodes providing the service data packet to the mobile terminal in a control domain of the base station in a combination of the foregoing second and third embodiments of the invention. In the embodiment of the invention, the base station can also receive the service data packet provided from each of the radio sensor nodes and access the radio communication network and therefore can be regarded as a sink node in the radio sensor network.

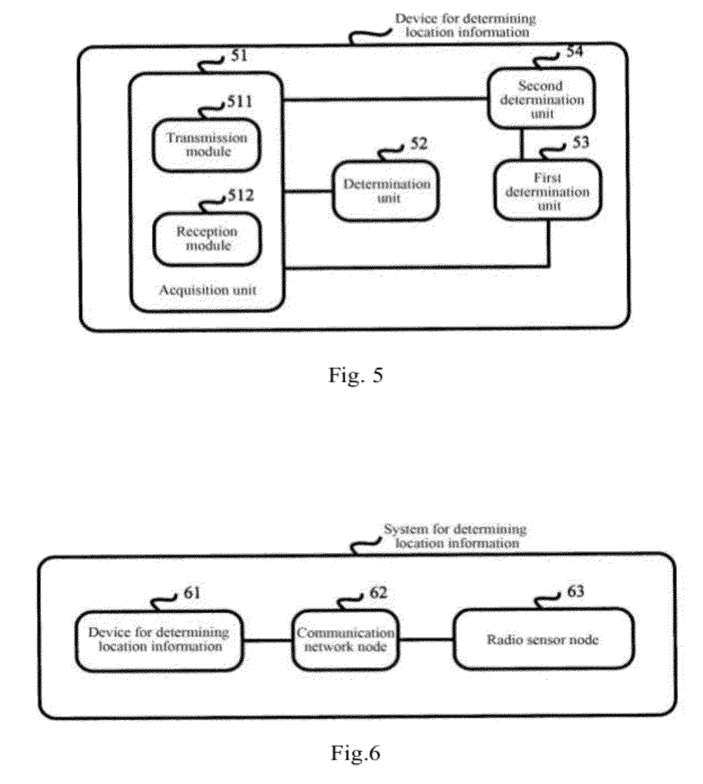

Correspondingly an embodiment of the invention provides a device for determining location information, which is applied in a radio sensor network, and FIG. 5 illustrates a schematic diagram of a specific structure of the device for determining location information, which includes the following functional units:

an acquisition unit 51 configured to acquire current location information of a communication network node in the radio sensor network; and

a determination unit 52 configured to determine the location information acquired by the acquisition unit 51 as current location information of a radio sensor node providing service data received by the communication network node at its own current location.

In correspondence to an implementation of the function of the acquisition unit 51, the acquisition unit 51 according to the embodiment of the invention can further be divided into functional modules as illustrated in FIG. 5:

a transmission module 511 configured to transmit a Location Based Service LBS service request to a LBS platform; and

a reception module 512 configured to receive the current location information of the communication network node fed back from the LBS platform in response to the LBS service request transmitted from the transmission module 511.

Preferably the device for determining location information according to the embodiment of the invention can further include a first determination unit 53 as illustrated in FIG. 5 configured to determine whether the communication network node receives an indicator before the acquisition unit acquires the current location information of the communication network node in the radio sensor network, where the indicator indicates a necessity to determine the current location information of the radio sensor node providing the service data received by the communication network node.

Furthermore in an embodiment of the invention, if a high requirement is taken into account on the precision at which the radio sensor node is positioned, then the device for determining location information according to the embodiment of the invention can further include a second determination unit 54 as illustrated in FIG. 5 configured to determine whether the distance between the communication network node and the radio sensor node is not above a preset distance threshold before the acquisition unit 51 acquires the current location information of the communication network node in the radio sensor network.

In an embodiment of the invention, the functions of the first determination unit 53 and the second determination unit 54 can be used in combination. For example, firstly the first determination unit 53 can determine that the communication network node receives the indicator and further the determination unit 54 can determine that the distance between the communication network node and the radio sensor node is not above the preset distance threshold before the acquisition unit 51 acquires the current location information of the communication network node in the radio sensor network. On the contrary, firstly the determination unit 54 can determine that the distance between the communication network node and the radio sensor node is not above the preset distance threshold and further the first determination unit 53 can determine that the communication network node receives the indicator before the acquisition unit 51 acquires the current location information of the communication network node in the radio sensor network.

In the device for determining location information according to the embodiment of the invention, the communication network node can be but not limited to a sink node in the radio sensor network or a bases station to which the sink node is subordinated.

Furthermore an embodiment of the invention further provides a system for determining location information, which is applied in a radio sensor network, and FIG. 6 illustrates a schematic diagram of a specific structure thereof including a device for determining location information 61, a communication network node 62 and a radio sensor node 63, where the device for determining location information 61 is configured to acquire current location information of the communication network node in the radio sensor network and to determine the location information of the communication network node as current location information of the radio sensor node providing service data received by the communication network node at its own current location, and the radio sensor node 63 is configured to provide the communication network node 62 with the serviced data.

Evidently those skilled in the art can make various modifications and variations to the invention without departing from the scope of the invention. Thus the invention is also intended to encompass these modifications and variations thereto so long as the modifications and variations come into the scope of the claims appended to the invention and their equivalents.

1. A method for determining location information, comprising:
acquiring current location information of a communication network node in a network;
determining the acquired location information as current location information of a radio sensor node providing service data to the communication network node;
writing the determined current location information of the radio sensor node into data bits reserved for writing the location information in a service data packet constituted of the service data; and
providing a corresponding demander with the service data packet into which the current location information of the radio sensor node is written.

2. The method of claim 1, wherein acquiring the current location information of the communication network node comprises:
acquiring the current location information of the communication network node using a global positioning system receiver of the communication network node; or acquiring the current location information of the communication network node through positioning a cell; or
transmitting a Location Based Service, LBS, service request to a LBS platform and receiving the current location information of the communication network node fed back from the LBS platform in response to the LBS service request.

3. The method of claim 1, further comprising: before acquiring the location information of the communication network node in the network,
determining whether the communication network node receives an indicator indicating a necessity to determine the current location information of the radio sensor node providing the service data to the communication network node.

4. (canceled)

5. The method of claim 1, further comprising: after determining the acquired location information as the current location information of the radio sensor node providing the service data to the communication network node,
providing a corresponding demander with a correspondence relationship between the determined current location information of the radio sensor node and information of a service data packet constituted of the service data.

6. The method of claim 1, further comprising: before acquiring the current location information of the communication network node in the network,
determining whether a distance between the communication network node and the radio sensor node is not above a preset distance threshold.

7. The method of claim 1, wherein the communication network node is a sink node in the network or a base station to which the sink node is subordinated.

8. A device for determining location information, comprising:
an acquisition unit configured to acquire current location information of a communication network node in a network;
a determination unit configured to determine the location information acquired by the acquisition unit as current location information of a radio sensor node providing service data to the communication network node;
a service data packet writing unit configured to write the current location information of the radio sensor node determined by the determination unit into data bits reserved for writing the location information in a service data packet constituted of the service data; and
a first providing unit configured to provide a corresponding demander with the service data packet generated by the service data packet writing unit.

9. The device of claim 8, wherein the acquisition unit comprises:
a transmission module configured to transmit a Location Based Service, LBS, service request to an LBS platform; and
a reception module configured to receive the current location information of the communication network node fed back from the LBS platform in response to the LBS service request transmitted from the transmission module.

10. The device of claim 8, further comprising:
a first determination unit configured to determine whether the communication network node receives an indicator before the acquisition unit acquires the current location information of the communication network node in the network, wherein the indicator indicates a necessity to determine the current location information of the radio sensor node providing the service data to the communication network node.

11. (canceled)

12. The device of claim 8, further comprising:
a second providing unit configured to provide a corresponding demander with a correspondence relationship between the current location information of the radio sensor node determined by the determination unit and information of a service data packet constituted of the service data.

13. The device of claim 8, further comprising:
a second determination unit configured to determine whether a distance between the communication network node and the radio sensor node is not above a preset distance threshold before the acquisition unit acquires the current location information of the communication network node in the network.

14. The device of claim 8, wherein the communication network node is a sink node in the network or a base station to which the sink node is subordinated.

15. A system for determining location information, applicable in a radio sensor network, comprising:
a communication network node;
a radio sensor node configured to provide the communication network node with service data; and
a location information determination device configured to acquire current location information of the communication network node in the network, determine the acquired location information as current location information of the radio sensor node, write the determined current location information of the radio sensor node into data bits reserved for writing the location information in a service data packet constituted of the service data, and provide a corresponding demander with the service data packet into which the current location information of the radio sensor node is written.

16. The system of claim 15, wherein the communication network node is a mobile terminal or a base station in the network.
